(19) United States
(12) Patent Application Publication
(10) Pub. No.: US 2026/0225052 A1
(43) Pub. Date: Aug. 6, 2026

(54) APPARATUS FOR BOTANICAL COMPOUND INFUSION AND HYDRODYNAMIC PRODUCTION OF NANO SCALE BIO-REACTIVE PARTICLES

(71) Applicant: 4EA, INC, TULSA, OK (US)

(72) Inventor: Paul Aston, Santee, CA (US)

(21) Appl. No.: 19/042,951

(22) Filed: Jan. 31, 2025

(51) Int. Cl. B01F 23/41; B01F 23/45; B01F 35/21; B01F 35/71

(52) U.S. Cl. CPC B01F 23/4146; B01F 23/45; B01F 35/2111; B01F 35/71805

(57) ABSTRACT

The invention relates to an apparatus for infusing organic or botanical compounds and producing nanoscale bio-reactive particles using hydrodynamic processes. It enhances concentrate stability and bioavailability by incorporating a chemically inert infusion chamber, a hydrodynamic conduit designed for laminar flow, and a precision flow control system. A proprietary formulation prevents particle aggregation and optimizes dispersion. Hydrodynamic forces reduce particle size to the nanoscale, creating stable, highly bioavailable emulsions. Adaptable across industries, including pharmaceuticals, beverages, functional foods, cosmetics and veterinary applications, the system enables enhanced drug delivery, nutrient-enriched food and beverages, tailored formulations for unique metabolic needs, as well as stable topical formulations. By leveraging optimized particle size and laminar flow dynamics, this invention ensures efficient, scalable production of high-quality emulsions. It advances bio-reactive particle production by integrating innovative engineering and chemistry, setting a new standard for concentrate manufacturing.

### PRIORITY CLAIM TO PRIOR FILED APPLICATION

This application claims priority to prior filed Provisional Patent Application No. 63/627,390 filed on Jan. 31, 2024.

### BACKGROUND

### Field of Use

This device pertains to the field of concentrate production, specifically focusing on an apparatus that enables the infusion of organic or botanical compounds. It facilitates the creation of nanoscale bio-reactive particles through optimized hydrodynamic processes. Our device is differentiated from others due to the specific parameters, pressures, velocity, and capability to keep organic compounds finely separated even when subjected to polar solvents that would otherwise cause the organic constituents to sequester themselves into masses that have exceedingly low bioavailability.

### Background of Prior Art

Conventional concentrate production methods face challenges, particularly in maintaining stability and bioavailability of organic compounds during infusion. Many systems result in particle sequestration into low-bioavailability masses, especially when exposed to polar solvents. This invention addresses these challenges with proprietary formulations, specific pressures, and unique hardware.

This apparatus is differentiated from other options due to the specific parameters, pressures, velocity, and capability to keep organic compounds finely separated even when subjected to polar solvents that would otherwise cause the organic constituents to sequester themselves into masses that have exceedingly low bioavailability.

Applicant has made many attempts at perfecting this design and it was not easy. It took Applicant several iterations of the infusion chamber and flow control system to fine tune nano-sizing and stabilization as well as machinability, maintenance, and manufacturing costs. Each step of the process yielded insight as to how this equipment could be made cost-effectively and still reach the desired level of performance necessary.

### DESCRIPTION

It is imperative to note that the terminology employed herein is exclusively for the purpose of delineating specific embodiments and is not intended to impose limitations on the invention. The term “and/or” encompasses any and all conceivable combinations of one or more of the associated items. Furthermore, singular forms such as “a,” “an,” and “the” encompass plural forms as well as singular forms unless the context clearly dictates otherwise. The terms “comprises” and “comprising,” when used in this context, signify the presence of the stipulated features, steps, operations, elements, and/or components, without excluding the presence or incorporation of other features, steps, operations, elements, components, and/or groups thereof.

It is essential to underscore that, unless expressly defined, all terms used herein, including technical and scientific terminology, possess the same meanings as those commonly understood by individuals with ordinary skill in the pertinent field. Such terms, when not explicitly defined herein, should be construed in a manner that aligns with their meanings in the context of the relevant art and the disclosure presented herein. The innovation at the core of this application centers around a specialized device designed for concentrate production. This device combines de-ionized water with a proprietary formulation to generate a concentrated emulsion featuring nanoscale particles. The formulation enables the rapid movement of viscous organic compounds, even as they re-arrange into particles. Additionally, other proprietary compounds play essential roles in this process, contributing to the desired outcome.

The invention comprises an apparatus that utilizes hydrodynamic principles to produce highly stable emulsions with nanoscale bio-reactive particles. The core of the invention is its ability to optimize particle size, surface area, and bioavailability through controlled pressures, velocities, and laminar flow conditions.

One remarkable aspect of this device is its capacity to induce hydrodynamics within the infusion chamber. This dynamic environment reduces the time available for the infused compounds to form particles. It is crucial to emphasize that the infusion process increases bio-availability due to our proprietary formulation in conjunction with particle size. Nano-sizing serves to increase surface area, further augmenting absorbability, while also significantly enhancing the stability of the emulsion.

In the realm of fluid dynamics, it is widely acknowledged that water naturally flows in swirling patterns rather than straight lines. In conduits with rigid inner walls, friction arises at the interface between water molecules and the conduit's surface. Conduit surfaces at the molecular scale are not perfectly smooth; they exhibit bumps, ridges, and various imperfections. Polishing can reduce these imperfections, but complete elimination is unfeasible. The interactions between water molecules' slightly sticky “edges” and the conduit's atomic lattice slow them down and deflect their path, contributing to further impediments in the flow.

The molecular collisions within the flowing stream lead to energy-dissipating eddy currents, primarily at the microscale. While this turbulence has minimal impact at the macro scale, it disrupts the coherent flow of molecules at the micro level.

Our innovative device introduces a hydrodynamic conduit configuration, having a geometry conducive to laminar flow as water traverses the system. This flow diminishes relative pressure within the central core-stream, leading to faster downstream flow compared to the surrounding water. The reduced pressure in the core-stream results in a reduced interaction between water molecules and the inner conduit wall. These effects culminate in a reduction of eddy currents, promoting the transition to a more stable laminar flow and enhancing overall coherence within the stream.

It is imperative to underline that a coherent water stream flows more efficiently and carries a higher energy density, akin to the behavior of a coherent light beam or laser, which carries greater power density compared to typical spreading light beams. The coherent stream facilitates the accelerated dispersion of compounds, reducing the time available for them to form particles.

One key component of this invention is a specialized infusion chamber composed of a chemically inert, high-strength material that resists corrosion and minimizes interaction with polar solvents.

Another key component of this invention is the Flow Control System comprised of a modulating valve that enables precise control of infusion and flushing cycles and an infusant control valve that regulates the introduction of organic or botanical compounds to maintain consistency in the emulsion. This controlled flow prevents particles from aggregating, enhancing long-term stability.

In this invention the organic or botanical ingredients are mixed with a proprietary stabilizing agent to form the infusant. De-ionized water flows through the conduit having a geometry conducive to laminar flow. The infusant is introduced at a controlled rate via the infusion chamber ensuring efficient dispersion of particles. Reduced pressure in the core stream minimizes wall friction and turbulence. The hydrodynamic forces rapidly spread organic compounds, reducing interaction time, reducing particle size. The stabilized emulsion is output through the diverter valve.

A key advantage of this invention is enhanced bioavailability as nanoscale particle formation increases absorption rates in biological systems. Another key advantage is stability as the emulsion remains stable over extended periods without aggregation.

This invention boasts extensive operational capabilities, making it highly versatile for various applications within concentrate production applied across various industries, including beverages, cosmetics, and pharmaceuticals; including infusion of botanical flavors and nutrients into liquid bases, production of bioavailable drug emulsions, and creation of stable nano-emulsions for topical applications respectively.

This invention represents a significant advancement in organic or botanical compound infusion and concentrate production. The apparatus described ensures efficient, scalable, and high-quality production of bio-reactive emulsions with nanoscale particles.

### DESCRIPTION OF THE DRAWINGS

Embodiments of the present invention are illustrated as an example and are not limited by the figures of the accompanying drawings, in which like references may indicate similar elements and in which:

FIG. 1 shows a frontal view of the apparatus featuring the device elements or components: the infusion injector housing and device (1); the flow modulating valve (2); the infusant control valve (3); the output diverter valve (4); the output diverter valve control (5) ; the injector housing securing ring and mating receptacle (6); the hydrodynamic chamber (7); the water or flow control valve (8); and the water and infusant flow meter control sight window and measurement device (9).

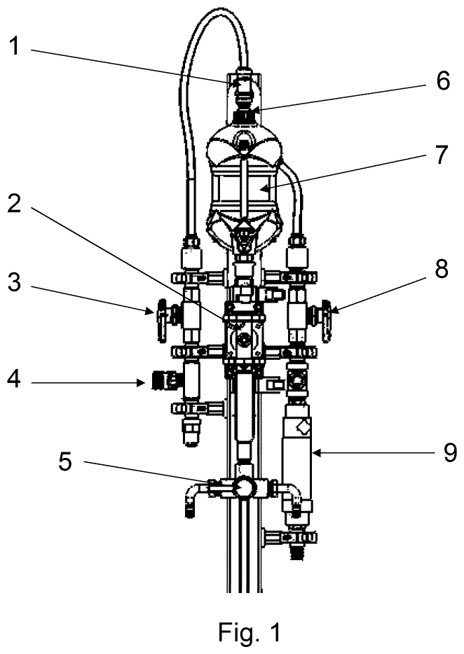

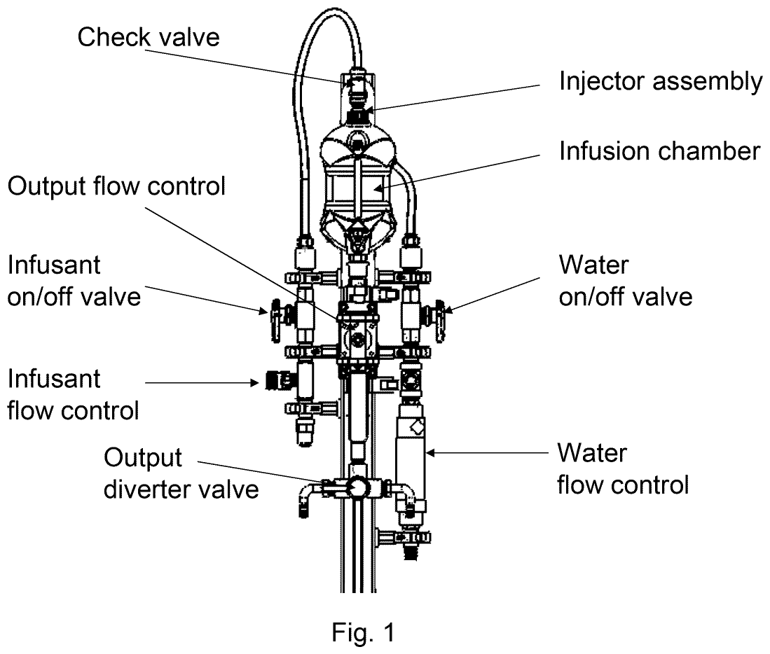

What is claimed is:

1. An apparatus for producing nanoscale bio-reactive particles through organic or botanical compound infusion, comprising: an at least one or more mixing chamber configured to introduce organic or botanical compounds into a liquid; an at least one or more conduit having a geometry conducive to laminar flow, wherein said conduit reduces turbulence and facilitates the formation of nanoscale particles; an at least one or more flow control system comprising an at least one or more modulating valve and an at least one or more infusant control valve to regulate flow rates and infusion cycles; an at least one or more hydrodynamic chamber configured to create an at least one or more pressure differential and minimize molecular collisions during particle generation; and an at least one or more output diverter valve to direct the stabilized emulsion; wherein said apparatus reduces particle size and enhances bioavailability by optimizing hydrodynamic conditions and stabilizing the resulting emulsion.

2. The apparatus of claim 1 wherein said at least one or more conduit is constructed from materials selected from stainless steel, glass, or a polymer resistant to chemical corrosion.

3. The apparatus of claim 1, further comprising an at least one or more flow meter and an at least one or more sight window configured to monitor flow rate and infusion processes in real time.

4. The apparatus of claim 1 wherein said at least one or more hydrodynamic chamber operates at pressures between 10 and 100 psi to optimize nanoscale particle generation.

5. The apparatus of claim 1, further comprising an at least one or more automated control system configured to regulate flow rates, pressure, and temperature during infusion and particle generation.

6. The apparatus of claim 1, further comprising an at least one or more modular design allowing replacement or upgrading of the mixing chamber and flow control system.
